(19) United States
(12) Patent Application Publication
(10) Pub. No.: US 2024/0324575 A1
(43) Pub. Date: Oct. 3, 2024

(54) MOSQUITO NET TRAPPING DEVICE AND METHODS OF MAKING AND USING THE SAME

(71) Applicant: Chouaibou S. Mouhamadou, Brunswick, MD (US)

(72) Inventor: Chouaibou S. Mouhamadou, Brunswick, MD (US)

(21) Appl. No.: 18/615,224

(22) Filed: Mar. 25, 2024

Related U.S. Application Data
(60) Provisional application No. 63/455,441, filed on Mar. 29, 2023.
(60) Provisional application No. 63/527,500, filed on Jul. 18, 2023.

(51) Int. Cl. A01M 1/10; A01M 1/02; A45F 3/52

(52) U.S. Cl. CPC A01M 1/106; A01M 1/023; A45F 3/52

(57) ABSTRACT

The invention is a mosquito net trapping device (MTD) that can be installed on any type of mosquito net to transform it into a mosquito trapping net. The MTD includes a lid, a body, and a funnel that attach together to form a single device that cooperates with a mosquito net and collection bag. The MTD can also include a netting material box mounted by funnels and attach on top of bednets. Both embodiments trap mosquitoes and keep them in captivity. Once captured, the mosquitoes can be disposed of without biting humans and spreading disease, such as malaria. In this way, the disclosed MTD is effective at slowing or preventing the spread of malaria and other mosquito-borne diseases.

### CROSS-REFERENCE TO RELATED APPLICATIONS

This application claims priority to U.S. Provisional Patent Application No. 63/455,441 filed Mar. 29, 2023 and U.S. Provisional Patent Application No. 63/527,500 filed Jul. 18, 2023, the entire contents of which are hereby incorporated by reference herein.

### FIELD OF THE INVENTION

The presently disclosed subject matter is directed to a mosquito net trapping device and to methods of making and using the disclosed device (e.g., to control mosquitos, to manage resistance in malaria vector control, and the like).

### BACKGROUND OF THE INVENTION

Malaria is a mosquito-borne infectious disease characterized by fever, tiredness, vomiting and headaches, jaundice, seizures, coma, and even death in severe cases. Between 2015 and 2020, the morbidity and mortality attributed to malaria in sub-Saharan Africa increased from 212 million cases and 429,000 deaths to 241 million cases and 627,000 deaths in humans. Not only can mosquitoes carry diseases that afflict humans, they also transmit several diseases and parasites that affect animals (e.g., dogs, horses, and the like), such as heartworm, West Nile virus (WNV) and Eastern equine encephalitis (EEE). One major obstacle in controlling the spread of mosquito-borne illnesses is insecticide resistance in infectious mosquitoes. One proposed solution has been the use of different classes of insecticides in combination and/or in rotation in time and space in an effort to reduce the number of mosquitos. However, the use of insecticide combinations does not provide for long-term prevention of the emergence and selection of resistant phenotypes, and only temporarily mitigates their impact. In addition, the widespread use of insecticide combinations can be expensive and time consuming to put into practice. Further, the proportion of insecticide-resistant mosquitoes has risen rapidly in the first few years following intervention using different classes of insecticides, regardless of the vector control approach used. For example, in sub-Saharan Africa, insecticide resistance in mosquitoes has been observed in all malaria vector populations across the continent in just a few decades, with huge negative consequences on the malarial burden. It would therefore be beneficial to provide malaria vector control strategies to mitigate the impact of insecticide resistance and also stop the selection and spread of malaria and other mosquito-borne diseases and conditions.

### SUMMARY OF THE INVENTION

The presently disclosed subject matter is directed to a mosquito trapping device (Model 1). Particularly, the device comprises a lid defined by a planar surface with a top face and an opposed bottom face, a ridge extending from the bottom face of the planar surface, away from the lid, and a central opening that passes through the planar surface and ridge. The device also includes a body defined by a planar surface comprising a top face and an opposed bottom face and a flange extending from the bottom face of the planar surface, away from the body. The device includes a funnel defined by a top end and an opposed bottom end and an interior tapered passageway positioned between the top and bottom ends. The lid ridge releasably attaches to the body and the body flange releasably attaches to the funnel.

In some embodiments, the presently disclosed subject matter is directed to a method of trapping mosquitos. Particularly, the method comprises positioning a portion of mosquito netting defined by an opening between the lid and body of a mosquito trapping device (Model 1). The method includes exposing the mosquito trapping device to an ambient environment that includes mosquitoes, whereby mosquitos enter the mosquito trapping device via the lid central opening, pass through the net opening, pass through the body central opening, enter the funnel interior passageway, and exit at the funnel lower end to become trapped within the collection bag.

In some embodiments, the presently disclosed subject matter is directed to a method of preventing the spread of a mosquito-borne disease. Specifically, the method comprises positioning a portion of mosquito netting defined by an opening between the lid and body of the mosquito trapping device (Model 1), wherein the lid ridge releasably attaches to the body and the body flange releasably attaches to the funnel. The method includes releasably securing the lid and body together with the mosquito netting therebetween, wherein the netting opening is aligned with the central openings of the lid and body and attaching a collection bag about an exterior surface of the funnel. Mosquitos enter the mosquito trapping device via the lid central opening, pass through the net opening, pass through the body central opening, enter the funnel interior passageway, and exit at the funnel lower end to become trapped within the collection bag. The mosquitos are prevented from infecting a subject with the mosquito-borne disease due to being trapped in the collection bag.

In some embodiments, the presently disclosed subject matter is directed to a method of managing insecticide resistance in mosquitoes using a trapping device (Model 1). Particularly, the method comprises positioning a portion of mosquito netting in a high mosquito density area, the mosquito netting defined by an opening between the lid and body of the disclosed mosquito trapping device, wherein the lid ridge releasably attaches to the body and the body flange releasably attaches to the funnel. The method includes releasably securing the lid and body together with the mosquito netting therebetween, wherein the netting opening is aligned with the central openings of the lid and body and attaching a collection bag about an exterior surface of the funnel. Mosquitos enter the mosquito trapping device via the lid central opening, pass through the net opening, pass through the body central opening, enter the funnel interior passageway, and exit at the funnel lower end to become trapped within the collection bag. The spread of insecticide resistant mosquitoes is decreased by the trapping of the mosquitoes within the collection bag.

In some embodiments, the presently disclosed subject matter is directed to a method of controlling mosquitoes. Particularly, the method comprises positioning a portion of mosquito netting in a high mosquito density area, the mosquito netting defined by an opening between the lid and body of the mosquito trapping device, wherein the lid ridge releasably attaches to the body and the body flange releasably attaches to the funnel. The method includes releasably securing the lid and body together with the mosquito netting therebetween, wherein the netting opening is aligned with the central openings of the lid and body. The method includes attaching a collection bag about an exterior surface of the funnel, whereby mosquitos enter the mosquito trapping device via the lid central opening, pass through the net opening, pass through the body central opening, enter the funnel interior passageway, and exit at the funnel lower end to become trapped within the collection bag. The mosquitoes are thereby controlled in the high mosquito density region by the mosquito trapping device (Model 1).

In some embodiments, the mosquito trapping device includes a mosquito net defined by an opening, wherein the opening is positioned between the central opening of the lid and the central opening of the body.

In some embodiments, the presently disclosed subject matter is directed to a mosquito trapping device comprising one or more lids (Model 2). Each lid is defined by a planar surface with a top face and an opposed bottom face, a ridge extending from the bottom face of the planar surface, away from the lid, and a central opening that passes through the planar surface and ridge. The device also includes one or more bodies, each defined by a planar surface comprising a top face and an opposed bottom face, and a flange extending from the bottom face of the planar surface, away from the body. The device includes one or more funnels, each funnel defined by a top end and an opposed bottom end, and an interior tapered passageway positioned between the top and bottom ends. The device comprises a mosquito net defined by one or more openings, wherein each opening is positioned between the central opening of a lid and the central opening of a body. The device includes a box attached to the net, wherein the box includes a top surface comprising one or more openings aligned with the one or more openings in the mosquito net, such that the box is positioned below an upper surface of the mosquito net. Each lid ridge releasably attaches on a top side of the mosquito net through a mosquito net opening to a body positioned within an interior of the mosquito net, and each body flange releasably attaches to a funnel such that each funnel extends through a box opening and each funnel is positioned within an interior of the box.

In some embodiments, the presently disclosed subject matter is directed to a method of trapping mosquitos. Particularly, the method comprises positioning a portion of mosquito netting defined by an opening between the lid and body of a mosquito trapping device (Model 2). The method includes exposing the mosquito trapping device to an ambient environment that includes mosquitoes, whereby mosquitos enter the mosquito trapping device via the one or more lid central openings, pass through the one or more net openings, pass through the one or more body central openings, enter the one or more funnel interior passageways, and exit at a funnel lower end to become trapped within the interior of the box.

In some embodiments, the presently disclosed subject matter is directed to a method of preventing the spread of a mosquito-borne disease using the mosquito trapping device (Model 2). Specifically, the method comprises positioning a portion of mosquito netting defined by one or more openings between the one or more lids and one or more bodies of the mosquito trapping device, wherein the one or more lid ridges releasably attach to the one or more bodies and the one or more body flanges releasably attach to the one or more funnels. The method includes releasably securing the one or more lids and one or more bodies together with the mosquito netting therebetween, wherein each netting opening is aligned with a central opening of a lid and body. The method comprises attaching a collection bag about an exterior surface of each funnel, whereby mosquitos enter the mosquito trapping device via the lid central opening, pass through the net opening, pass through the body central opening, enter the funnel interior passageway, and exit at the funnel lower end to become trapped within the interior of the box. The mosquitos are prevented from infecting a subject with the mosquito-borne disease due to being trapped in the one or more collection bags.

In some embodiments, the presently disclosed subject matter is directed to a method of controlling mosquitoes using the mosquito trapping device (Model 2). Particularly, the method comprises positioning a portion of mosquito netting in a high mosquito density area, the mosquito netting defined by one or more openings between the one or more lids and one or more bodies of the mosquito trapping device, wherein each lid ridge releasably attaches to a body and each body flange releasably attaches to a funnel. The method includes releasably securing each lid and body together with the mosquito netting therebetween, wherein each netting opening is aligned with the central openings of the lid and body. Mosquitos enter the mosquito trapping device via the one or more lid central openings, pass through the one or more net openings, pass through the one or more body central openings, enter the one or more funnel interior passageways, and exit at the one or more funnel lower ends to become trapped within the interior of the box. The mosquitoes are controlled in the high mosquito density region.

In some embodiments, the presently disclosed subject matter is directed to a method of managing insecticide resistance in mosquitoes using a trapping device (Model 2). Particularly, the method comprising positioning a portion of mosquito netting in a high mosquito density area, the mosquito netting defined by one or more openings between the one or more lids and one or more bodies of the mosquito trapping device, wherein each lid ridge releasably attaches to a body and each body flange releasably attaches to a funnel. The method includes releasably securing each lid and body together with the mosquito netting therebetween, wherein each netting opening is aligned with the central openings of the lid and body. Mosquitos enter the mosquito trapping device via the one or more lid central openings, pass through the one or more net openings, pass through the one or more body central openings, enter the one or more funnel interior passageways, and exit at the one or more funnel lower ends to become trapped within the interior of the box. The spread of insecticide resistant mosquitoes is decreased by the trapping of the mosquitoes within the interior of the box.

In some embodiments, the lid central opening, body central opening, and top end of each funnel have a diameter of about 1-100 cm (e.g., at least/no more than about 1, 5, 10, 15, 20, 25, 30, 35, 40, 45, 50, 55, 60, 65, 70, 75, 80, 85, 90, 95, 100, or more). The diameter of the opening is not limited and can be configured in any suitable size.

In some embodiments, each funnel is angled between the top end and the bottom end with a degree of inclination of about 1-180 degrees (e.g., at least/no more than about 1, 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, or 180 degrees). Such a degree of inclination has been shown to effectively allow entrance of mosquitoes into the funnel interior through the top end yet deter mosquitoes from exiting the funnel through the top end (e.g., the mosquitoes travel in a one-way direction).

In some embodiments, each funnel comprises a plurality of openings along an external surface between the top end and the bottom end, and wherein the plurality of openings allow for the influx of light, disperse carbon dioxide, or both.

In some embodiments, the device further comprises a collection bag configured to attach around an exterior of the funnel.

In some embodiments, the collection bag has a volume of about 5-20 liters.

In some embodiments, the funnels are positioned lengthwise, widthwise, diagonally, or randomly.

In some embodiments, the mosquito-borne disease is selected from one or more of malaria, heartworm, West Nile virus, Eastern equine encephalitis (EEE), dengue fever, yellow fever, zika virus, Chagas disease, and encephalitis.

In some embodiments, the subject is a human or animal (dog, cat, horse, pig, goat, bird, horse, cattle, bison, sheep, deer, moose, elk, caribou, pig, rabbit, rodent, box, raccoon, camel, chicken, duck, goose, etc.). The term “animal” is non-limiting and includes any member of the animal kingdom.

### BRIEF DESCRIPTION OF THE DRAWINGS

FIG. 1a is an exploded view of a mosquito net trapping device in accordance with some embodiments of the presently disclosed subject matter.

FIG. 1b is perspective view of an assembled mosquito net trapping device in accordance with some embodiments of the presently disclosed subject matter.

FIG. 2a is a perspective view of a mosquito net trapping device lid in accordance with some embodiments of the presently disclosed subject matter.

FIG. 2b is a top plan view of a mosquito net trapping device lid in accordance with some embodiments of the presently disclosed subject matter.

FIG. 2c is a side plan view of a mosquito net trapping device lid in accordance with some embodiments of the presently disclosed subject matter.

FIG. 3a is a perspective view of a mosquito net trapping device body in accordance with some embodiments of the presently disclosed subject matter.

FIG. 3b is a top plan view of a mosquito net trapping device body in accordance with some embodiments of the presently disclosed subject matter.

FIG. 3c is a side plan view of a mosquito net trapping device body in accordance with some embodiments of the presently disclosed subject matter.

FIG. 4a is a perspective view of a mosquito net trapping device funnel in accordance with some embodiments of the presently disclosed subject matter.

FIG. 4b is a perspective view of a funnel comprising a neck in accordance with some embodiments of the presently disclosed subject matter.

FIG. 4c is a top plan view of a mosquito net trapping device funnel in accordance with some embodiments of the presently disclosed subject matter.

FIG. 4d is a side plan view of a mosquito net trapping device funnel in accordance with some embodiments of the presently disclosed subject matter.

FIG. 4e is a perspective side view of a mosquito net trapping device funnel in accordance with some embodiments of the presently disclosed subject matter.

FIG. 5a is an exploded view of a mosquito net trapping device in use in accordance with some embodiments of the presently disclosed subject matter.

FIG. 5b is a side plan view of a mosquito net trapping device lid and body secured together with netting in between in accordance with some embodiments of the presently disclosed subject matter.

FIGS. 5c and 5d are side plan views illustrating attaching a mosquito net trapping device funnel to a body in accordance with some embodiments of the presently disclosed subject matter.

FIG. 5e is a perspective view of a mosquito net trapping device assembled on a bed netting in accordance with some embodiments of the presently disclosed subject matter.

FIGS. 6a-6e illustrate one method of assembling the disclosed device.

FIG. 7 is a perspective view of a box in accordance with some embodiments of the presently disclosed subject matter.

FIGS. 8a and 8b illustrate a box positioned within a sleeping arrangement (netting) in accordance with some embodiments of the presently disclosed subject matter.

FIGS. 9a and 9b illustrate perspective views of assembling a box and/or mosquito netting box in accordance with some embodiments of the presently disclosed subject matter.

FIGS. 9c and 9d illustrate perspective views of adding a box on a mosquito netting sleeping arrangement in accordance with some embodiments of the presently disclosed subject matter.

FIG. 9e is a side view of a mosquito box affixed to a netting in accordance with some embodiments of the presently disclosed subject matter.

FIGS. 10a and 10b are top plan views of one method used to construct a funnel in accordance with some embodiments of the presently disclosed subject matter.

FIGS. 11a and 11b are perspective views of a mosquito net trapping device assembled on a bed netting in accordance with some embodiments of the presently disclosed subject matter.

FIGS. 12a-12c are top plan views of mosquito net trapping devices configured on bed nettings in accordance with some embodiments of the presently disclosed subject matter.

FIG. 13 is a bar graph illustrating bed net configuration versus mean daily mosquito collection number.

### DETAILED DESCRIPTION OF THE INVENTION

For the purpose of promoting an understanding of the principles of the present disclosure, reference will now be made to preferred embodiments and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

Articles “a” and “an” are used herein to refer to one or to more than one (i.e., at least one) of the grammatical object of the article. By way of example, “an element” means at least one element and can include more than one element. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise indicated, all numbers expressing quantities of components, conditions, and so forth used in the specification and claims are to be understood as being modified in all instances by the term “about.” Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments +/−20%, in some embodiments +/−10%, in some embodiments +/−5%, in some embodiments +/−1%, in some embodiments +/−0.5%, and in some embodiments +/−0.1%, from the specified amount, as such variations are appropriate in the disclosed packages and methods. Thus, the term “about” is used to provide flexibility to a numerical range endpoint by providing that a given value may be “slightly above” or “slightly below” the endpoint without affecting the desired result.

As used herein, the term “and/or” includes any and all combinations of one or more of the associated listed items.

Relative terms such as “below” or “above” or “upper” or “lower” or “horizontal” or “vertical” may be used herein to describe a relationship of one element, layer, or region to another element, layer, or region as illustrated in the drawing figures. It will be understood that these terms and those discussed above are intended to encompass different orientations of the device in addition to the orientation depicted in the drawing figures.

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

All methods described herein can be performed in any suitable order unless otherwise indicated herein or otherwise clearly contradicted by context. The use of any and all examples, or exemplary language (e.g., “such as”) provided herein, is intended merely to better illuminate the invention, and does not pose a limitation on the scope of the invention unless otherwise claimed. No language in the specification should be construed as indicating any unclaimed element as essential to the practice of the invention.

Unless otherwise defined, all technical terms used herein have the same meaning as commonly understood by one of ordinary skill in the art to which this disclosure belongs.

In a first embodiment, the presently disclosed subject matter is directed to a mosquito net trapping device (MTD) that can be installed on any type of mosquito net to transform it into a mosquito trapping net. The term “mosquito net” refers broadly to any type of meshed curtain or material that can be circumferentially draped over a bed, sleeping area, or any desired area to offer the user barrier protection against bites and stings from mosquitoes, flies, and other insects (and the associated diseases the insects carry). The mosquito net is typically fine enough to exclude mosquitoes and other insects without obscuring ventilation or visibility to unacceptable levels. Mosquito netting is often installed over beds as a means of preventing mosquito bites that can occur during the night when mosquitoes are most active and unsuspecting victims are fast asleep. Mosquito netting is typically comprised of an ultra-fine, see-through mesh material that prevents insects from biting humans. In some embodiments, the nets are treated with an insecticide solution that serves to further enhance their use.

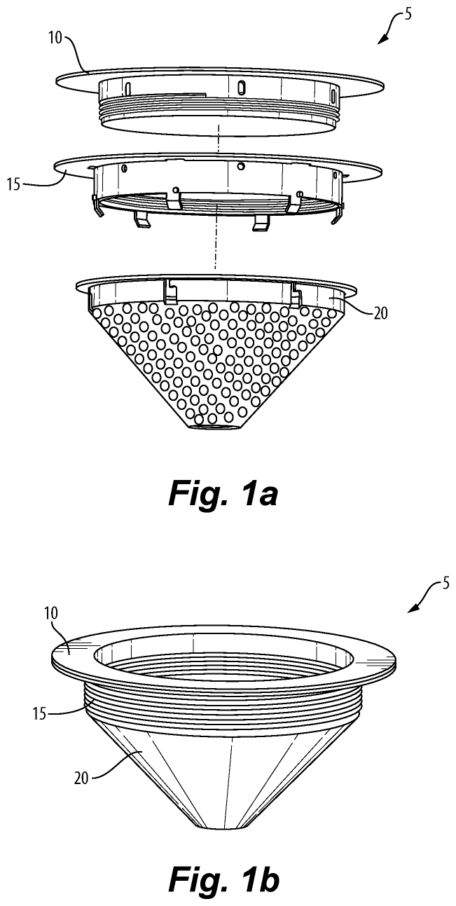

The term “mosquito” as used herein refers to an insect of the family Culicidae and can include any mosquito species, such as (but not limited to) Anopheles, Aedes, Culex, and Haemagogus. In some embodiments, the mosquitoes are of a species that can carry malaria (or any other mosquito-carried illness) and infect humans. As illustrated in FIGS. 1a and 1b, one embodiment of MTD 5 includes lid 10, body 15, and funnel 20 that attach together to form a single device that cooperates with a mosquito net and/or a collection bag to trap mosquitoes and keep them in captivity. Once captured, the mosquitoes can be disposed of without biting humans and spreading disease. In this way, the disclosed MTD is effective at slowing or preventing the spread of malaria and other mosquito-borne diseases.

The term “malaria” refers to a mosquito-borne infectious disease that affects humans and other vertebrates. Human malaria causes symptoms that typically include fever, fatigue, vomiting, and headaches. In severe cases, malaria can cause jaundice, seizures, coma, or death. Symptoms typically begin 10 to 15 days after being bitten by an infected Anopheles mosquito. If not properly treated, people may have recurrences of the disease months later. Human malaria is caused by single-celled microorganisms of the Plasmodium group. It is spread exclusively through bites of infected female Anopheles mosquitoes. The mosquito bite introduces the parasites from the mosquito's saliva into a person's blood. The parasites travel to the liver where they mature and reproduce. Five species of Plasmodium commonly infect humans. The three species associated with more severe cases are P. falciparum (which is responsible for the vast majority of malaria deaths), P. vivax, and P. knowlesi (a simian malaria that spills over into thousands of people a year). P. ovale and P. malariae generally cause a milder form of malaria.

Other mosquito-borne or mosquito-transmitted (e.g., transmitted via the bite of a mosquito) diseases include (but are not limited to) heartworm, West Nile virus, Eastern equine encephalitis (EEE), dengue fever, yellow fever, zika virus, Chagas disease, and encephalitis.

“Heartworm” refers to Dirofilaria immitis, a parasitic roundworm that is a type of filarial worm (a small thread-like worm) that causes dirofilariasis. Heartworms spread from host to host through the bites of mosquitoes.

“West Nile virus” is a single-stranded RNA virus that causes West Nile fever. It is a member of the family Flaviviridae, from the genus Flavivirus, which also contains the Zika virus, dengue virus, and yellow fever virus. The virus is primarily transmitted by mosquitoes, mostly species of Culex. The primary hosts of WNV are birds, so that the virus remains within a “bird-mosquito-bird” transmission cycle. The virus is genetically related to the Japanese encephalitis family of viruses. Humans and horses both exhibit disease symptoms from the virus, and symptoms rarely occur in other animals.

“Eastern equine encephalitis” refers to a disease caused by a zoonotic mosquito vectored Togavirus that is present in North, Central, and South America, and the Caribbean. EEEV is capable of infecting a wide range of animals, including mammals, birds, reptiles, and amphibians. The virus is maintained in nature through a bird-mosquito cycle.

Dengue fever is a mosquito-borne tropical disease caused by the dengue virus. It is frequently asymptomatic; if symptoms appear they typically begin 3 to 14 days after infection. Typical symptoms include a high fever, headache, vomiting, muscle and joint pains, and characteristic skin itching and skin rash. Recovery generally takes two to seven days. In a small proportion of cases, the disease develops into severe dengue with bleeding, low levels of blood platelets, blood plasma leakage, and dangerously low blood pressure. Dengue fever is spread by several species of female mosquitoes of the Aedes genus, principally Aedes aegypti.

Yellow fever is a viral disease with a typically short duration. In most cases, symptoms include fever, chills, loss of appetite, nausea, muscle pains (particularly in the back), and headaches. Symptoms typically improve within five days. In about 15% of people, within a day of improving the fever comes back, abdominal pain occurs, and liver damage begins causing yellow skin. If this occurs, the risk of bleeding and kidney problems is increased. The disease is caused by the yellow fever virus and is spread by the bite of an infected mosquito. Yellow fever infects humans, other primates, and several types of mosquitoes. In cities, yellow fever is spread primarily by Aedes aegypti, a type of mosquito found throughout the tropics and subtropics. The virus is an RNA virus of the genus Flavivirus.

Zika virus is a member of the virus family Flaviviridae and is spread by daytime active Aedes mosquitoes, such as A. aegypti and A. albopictus. Infection often causes no or only mild symptoms, similar to a very mild form of dengue fever.

Chagas disease is a tropical parasitic disease caused by Trypanosoma cruzi. It is spread mostly by insects in the subfamily Triatominae, known as “kissing bugs”. The symptoms change over the course of the infection. In the early stage, symptoms are typically either not present or mild, and may include fever, swollen lymph nodes, headaches, or swelling at the site of the bite. After four to eight weeks, untreated individuals enter the chronic phase of disease, which in most cases does not result in further symptoms. Up to 45% of people with chronic infections develop heart disease 10-30 years after the initial illness, which can lead to heart failure. Digestive complications, including an enlarged esophagus or an enlarged colon, may also occur in up to 21% of people, and up to 10% of people may experience nerve damage. T. cruzi is commonly spread to humans and other mammals by the kissing bug's bite wound and infected feces. The disease may also be spread through blood transfusion, organ transplantation, consuming food or drink contaminated with the parasites, and vertical transmission (from a mother to her baby).

“Encephalitis” refers to inflammation of the brain. The severity can be variable with symptoms including reduction or alteration in consciousness, headache, fever, confusion, a stiff neck, and vomiting. Complications may include seizures, hallucinations, trouble speaking, memory problems, and problems with hearing. Causes of encephalitis include viruses such as herpes simplex virus and rabies virus as well as bacteria, fungi, or parasites.

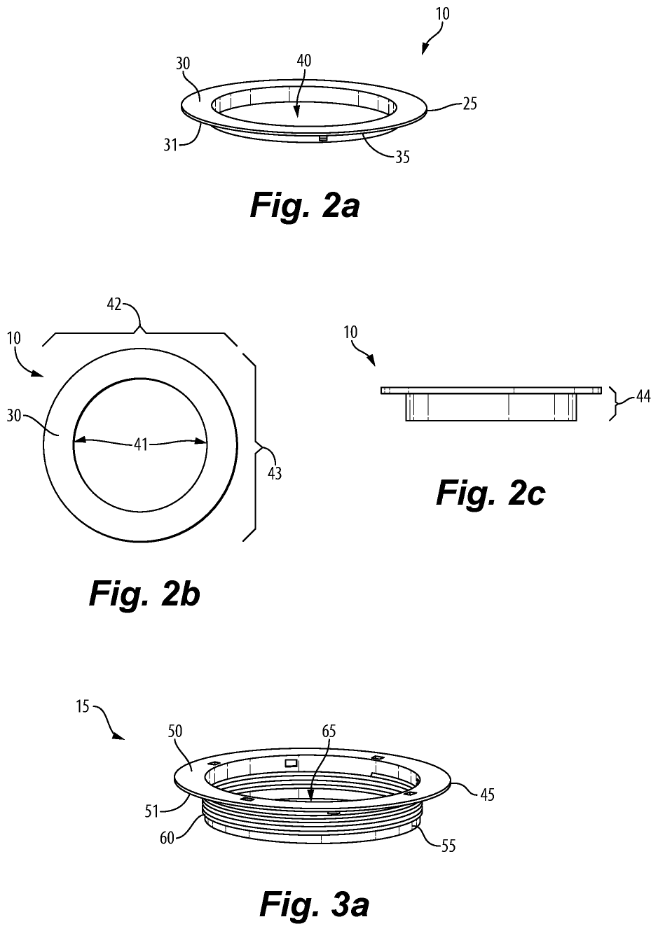

FIG. 2a illustrates one embodiment of MTD lid 10 that cooperates with the MTD body to attach a portion of netting therebetween. As shown, the lid comprises top planar surface 25 defined by upper and lower faces 30, 31. The bottom face of the planar surface includes downward-extending ridge 35 that allows the lid to cooperate with body 15. For example, in some embodiments the outer and/or inner surface of ridge 35 can include external threads that enable the lid to releasably attach to the body. However, it should be appreciated that any element can be used to attach the lid to the body (e.g., the use of clips, magnets, ties, fasteners, straps, screws, adhesive, welding, and the like). The lid further includes central opening 40 that extends through the planar surface and ridge 35. As discussed in detail below, central opening 40 allows mosquitos to gain access to MTD 5 by forming a trap entrance.

Lid 10 can be configured in any of a variety of dimensions. To this end, central opening 40 can have any suitable diameter 41. The term “diameter” refers to a straight line passing from side to side through the center of a body, as shown in FIG. 2b. In some embodiments, diameter 41 of the central opening can be about 15 cm (e.g., at least/no more than about 5, 10, 15, 20, 25, or 30 cm). In some embodiments, lid 10 can include length 42 and/or thickness 43 of about 10-40 cm (e.g., at least/no more than about 10, 15, 20, 25, 30, 35, or 40 cm). The term “length” refers to the longest straight-line horizontal distance of an item (e.g., from a left-most side to a right-most side). The term “thickness” refers to the longest straight-line distance from a front face of an element to a rear face of an element, as shown in FIG. 2b. The lid can also include width 44 of about 3-10 cm (at least/no more than about 3, 4, 5, 6, 7, 8, 9, or 10 cm). The term “width” refers to the longest straight line vertical distance of an element, as shown in FIG. 2c. It should be appreciated that the diameter, length, width, and thickness of the lid is not limited and can be configured outside the ranges given above.

Lid 10 can be constructed from any suitable material, such as (but not limited to) metal (e.g., copper, stainless steel, etc.), wood, plastic, ceramics, rubber, cardboard, or combinations thereof.

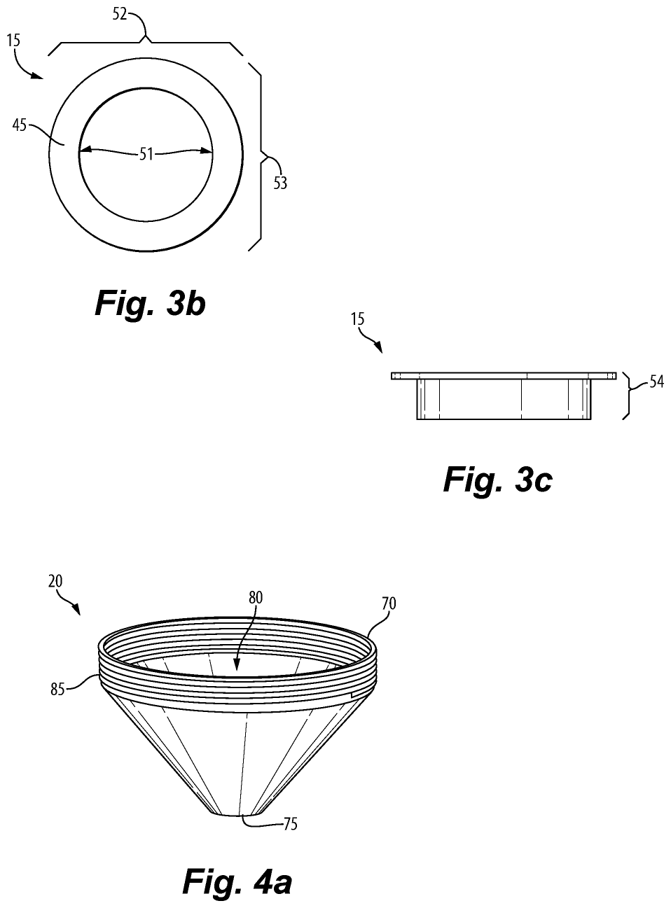

As described in detail below, lid 10 releasably attaches to body 15 with a portion of mosquito net fixed therebetween. One embodiment of body 15 is illustrated in FIG. 3a. As shown, body 15 comprises planar top surface 45 defined by upper and lower faces 50, 51. The lower face includes downward-extending flange 55. In some embodiments, the exterior and/or interior surface of flange 55 can include a connection element (such as threads 60) that allow the body to attach to funnel 15. It should be appreciated that any attachment mechanism and elements can be used to releasably attach the lid to the body, such as screw threads, magnets, clips, fasteners, ties, straps, screws, adhesive, welding, VELCRO®, and the like. Body 15 further includes central opening 65 that extends through planar surface 45 and flange 55, providing a passageway. Mosquitos can therefore enter the MTD via central opening 40 of the lid and continue through central opening 65 of the body that together form a passageway that leads mosquitos to the funnel.

Central opening 65 of the body can have any suitable diameter. For example, diameter 51 of the body central opening can be about 15 cm (e.g., at least/no more than about 5, 10, 15, 20, 25, or 30 cm). In some embodiments, the body can include length 52 and/or thickness 53 of about 10-40 cm (e.g., at least/no more than about 10, 15, 20, 25, 30, 35, or 40 cm), as illustrated in FIG. 3b. The body can also include width 54 of about 3-15 cm (at least/no more than about 3, 4, 5, 6, 7, 8, 9, 10, 11, 12, 13, 14, or 15 cm), as shown in FIG. 3c. It should be appreciated that the diameter, length, width, and thickness of the body are not limited and can be configured outside the ranges given above. In some embodiments, the diameter of the body central opening can be about the same as the lid central opening (e.g., exactly the same or differing by 5% or less).

The MTD body can be constructed from any suitable material, such as (but not limited to) metal (e.g., copper, stainless steel, etc.), wood, plastic, ceramics, rubber, cardboard, or combinations thereof.

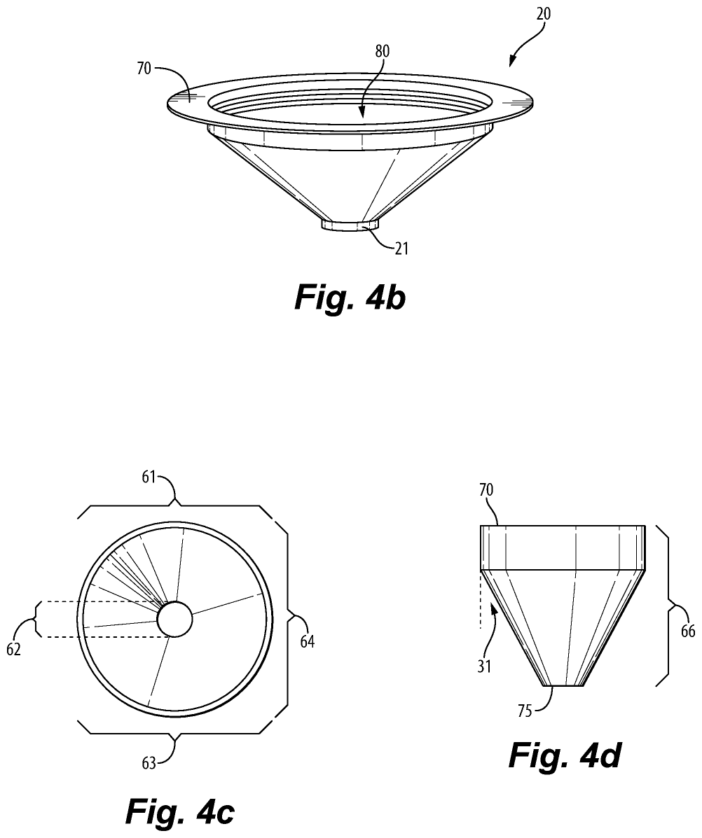

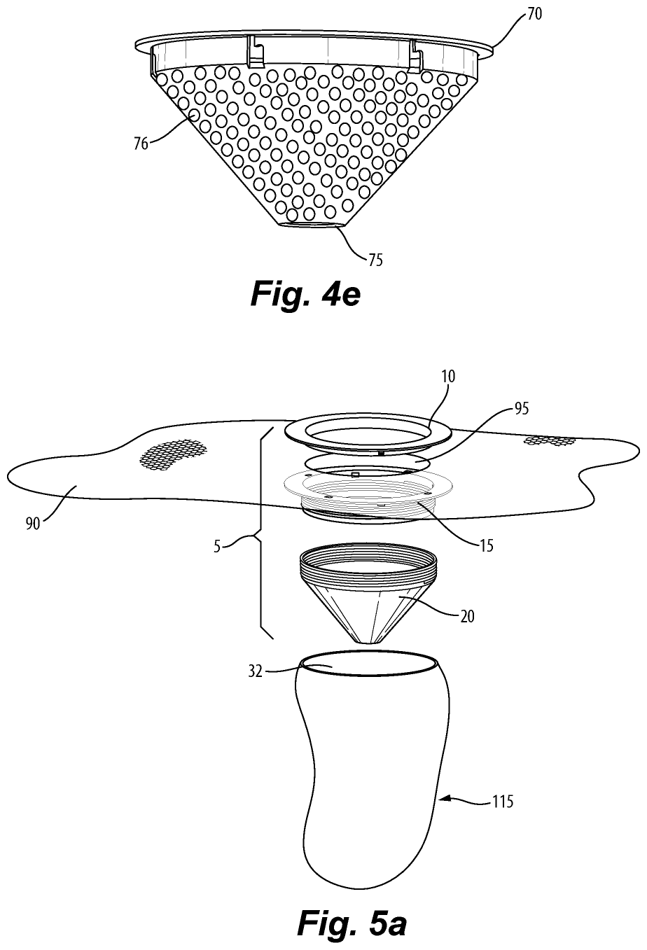

FIG. 4a illustrates one embodiment of funnel 20 that releasably attaches to the lower edge of flange 55 of the body. The funnel comprises upper end 70 that tapers to lower end 75 with internal passageway 80 that runs through the funnel. Thus, the funnel includes open upper end 70 and a smaller, tapered opening at lower end 75. In some embodiments, the upper end includes a connection element, such as threads 85, that allow the funnel to releasably attached to body 15. However, any connection element can be used (e.g., magnets, threads, fasteners, clips, ties, and the like). The funnel directs mosquitoes to a capture chamber, thereby preventing the mosquitoes from biting humans and thereby transmitting malaria or other mosquito-transmitted illnesses. Once in the capture chamber, the mosquitos can be disposed of and are unable to escape.

Optionally, the funnel can include neck 21, as shown in FIG. 4b. The term “neck” refers to a narrow region that can act as a collar at the lower end of the funnel. The neck can assist in retaining mosquitoes within the interior of the device and/or attachment to a collection bag.

As shown in FIG. 4c, central opening 80 of the funnel can have any suitable diameter. For example, the diameter 61 of the central opening at upper end 70 can be about 15 cm (e.g., at least/no more than about 5, 10, 15, 20, 25, or 30 cm), while diameter 62 of the central opening at lower end 75 can be about 2-10 cm (e.g., at least/no more than about 2, 3, 4, 5, 6, 7, 8, 9, or 10 cm), as shown in FIG. 4c. In some embodiments, the funnel can include length 63 and/or thickness 64 of about 10-40 cm (e.g., at least/no more than about 10, 15, 20, 25, 30, 35, or 40 cm). The funnel can further comprise width 66 of about 10-60 cm (e.g., at least/no more than about 10, 15, 20, 25, 30, 35, 40, 45, 50, 55, or 60 cm), as illustrated in FIG. 4c. It should be appreciated that the diameter, length, width, and thickness of the funnel is not limited and can be configured outside the ranges given above. The diameter 61 of the funnel can be about the same as the body central opening to allow for attachment. Thus, diameter 61 can be about the same or slightly larger or smaller (e.g., 10%, 5%, 3%, 2%, 1% or less difference).

As noted, funnel 20 is angled or tapered from upper end 70 to lower end 75. In some embodiments, any angle can be used. For example, degree of inclination 31 can be about 51.3 degrees, as shown in FIG. 4d. However, the angle is not limited and can be about 1-180 degrees (e.g., at least/no more than about 1, 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, or 180 degrees).

In some embodiments, funnel 20 can include a plurality of apertures 76 that allow for the influx of light within the interior of the MTD, as shown in FIG. 4e. For example, the apertures can be evenly distributed about the funnel or can be grouped together at a particular area (e.g., adjacent to the upper end and/or lower end). Any number of apertures can be used, and the apertures can be configured in any suitable size or shape. The funnel apertures function to increase the light reaching the interior of the MTD and facilitates the dispersion of carbon dioxide, both of which increase the attraction of mosquitoes. To this end, natural light can filter into the interior of the device through apertures 76. In other embodiments, an external light source can be used (e.g., light bulb or other element).

The funnel can be constructed from any suitable material, such as (but not limited to) metal (e.g., copper, stainless steel, etc.), wood, plastic, fiberglass, ceramics, rubber, cardboard, or combinations thereof.

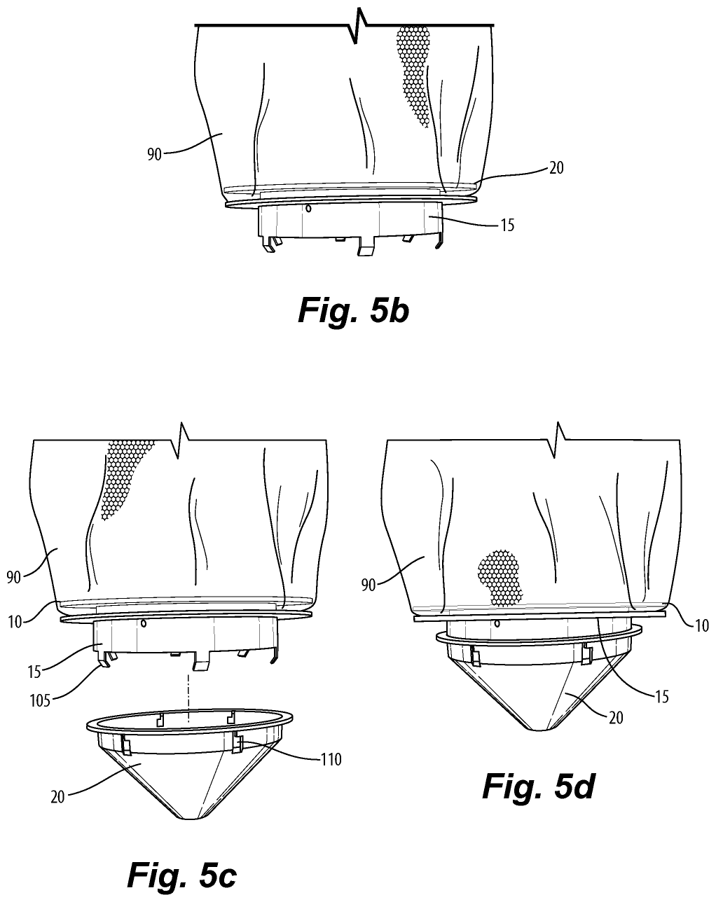

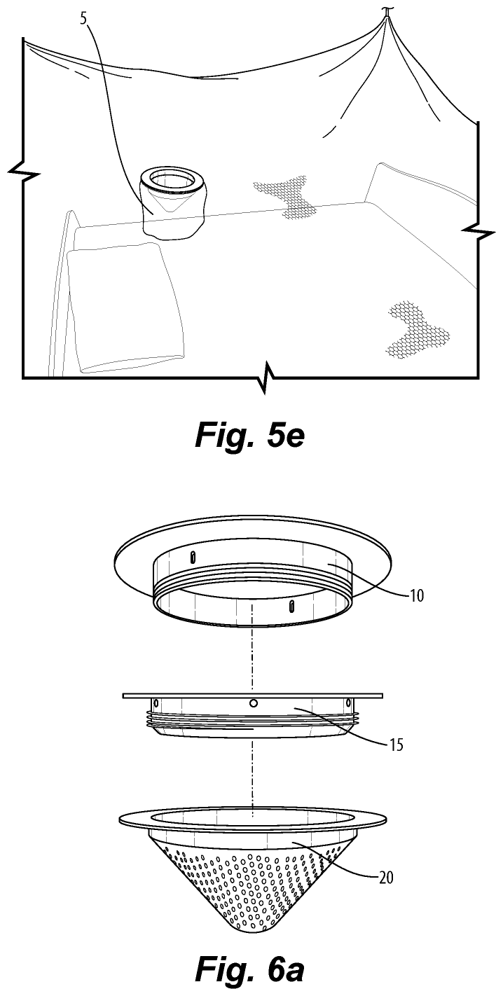

To assemble the first embodiment of MTD 5, lid 10 can be attached to body 15 by any suitable mechanism, such as by cooperating threads on the lower edge of the lid ridge 35 and a surface of the body. For example, the lid and the body can be twisted together as is known in the art. Thus, the lid can be releasably or permanently (e.g., through adhesive, welding, etc.) attached to the body. As shown in FIG. 5a, mosquito net 90 can be positioned between the lid and the body prior to joining the parts together. Specifically, the net includes aperture 95 that is aligned with the central openings in the lid and body to create a central passageway for the mosquitoes. Thus, when the lid and body are releasably attached together, net 90 is fixed therebetween, and positioned such that aperture 95 aligns with the lid and body central openings to provide a passageway for the mosquitos to reach funnel 20, as shown in FIG. 5b.

In some embodiments, retainer clips or any other suitable fastening elements can be used to further secure lid 10 to body 15 and prevent any movement of the lid relative to the body.

After the lid and body have been secured together with the net therebetween, funnel 20 can be releasably attached to the body using any suitable method, as illustrated in FIGS. 5c and 5d. For example, in some embodiments male and female screw threads can be used to attach the funnel to the body. In other embodiments, the bottom edge of body 15 includes angled legs 105 that can be inserted into corresponding openings 110 on the funnel. However, it should be appreciated that any attachment mechanism can be used.

After the funnel is assembled onto the body, collection bag 115 can be positioned around the exterior surface of funnel 20 to retain trapped mosquitoes in captivity. For example, opening 32 of the collection bag can be secured over the funnel in any suitable way, such as the use of clips, fasteners, and the like. In this way, the collection bag acts as a capture chamber for mosquitos that enter the MTD. Stated another way, mosquitos that enter the MTD enter via the lid central opening and travel through the body central opening to reach funnel 20. The mosquitos exit the funnel at lower end 75 and are then trapped within the interior of collection bag 115. The bag can be removed, and the trapped mosquitoes can then be disposed of. The mosquitoes cannot escape from the collection bag. FIG. 5e illustrates one embodiment of the MTD installed on a bed netting. As shown the opening of the lid and the central passageway of the device is open to the exterior environment, such that mosquitoes can enter the device and become trapped within the collection bag that is positioned within the interior of the netting.

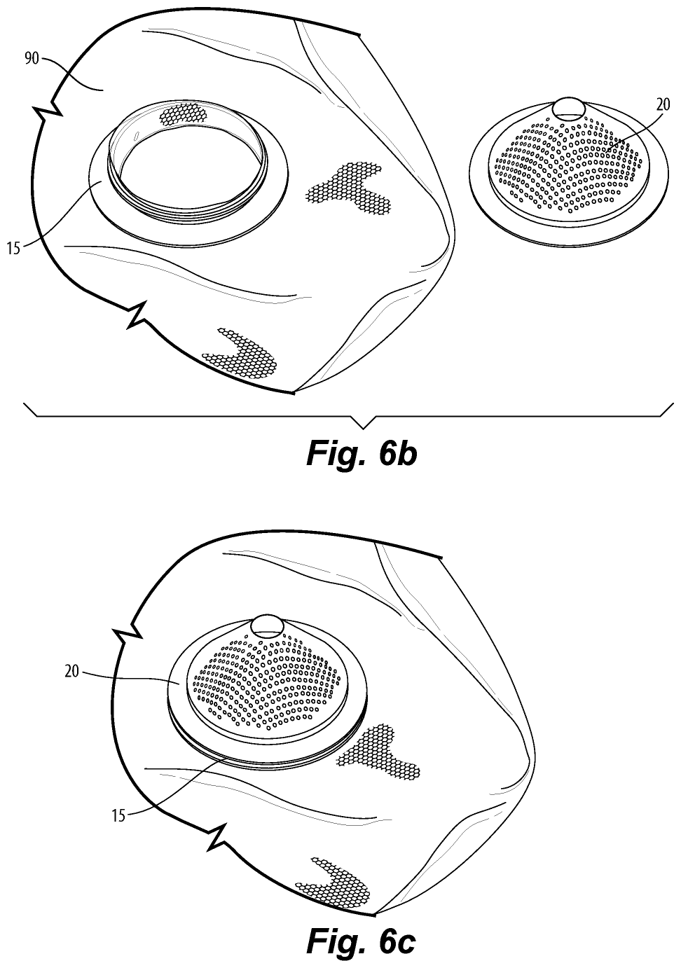

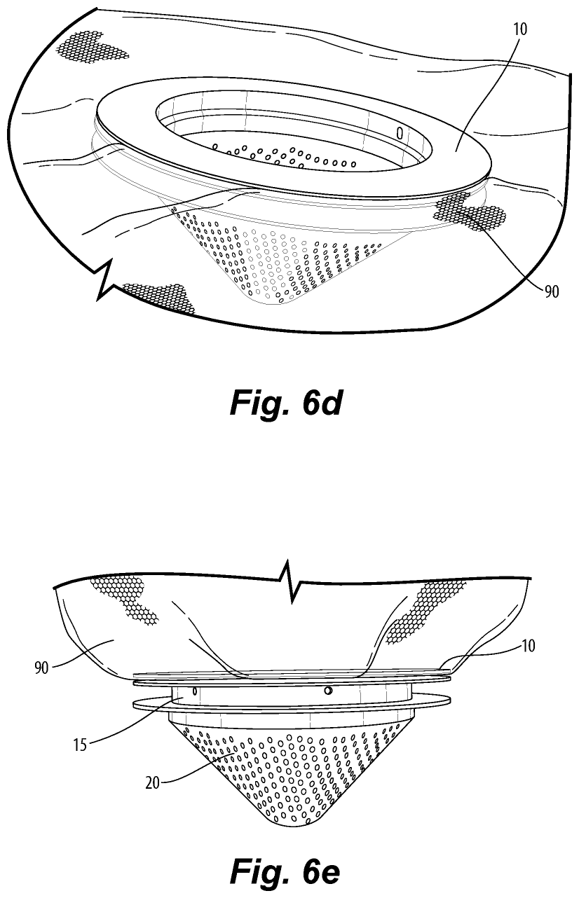

FIGS. 6a-6e illustrate another embodiment of assembling the MTD. As shown in FIG. 6a, the MTD can include funnel 20, body 15, and lid 10 that cooperate with netting 90 or a trapping bag. The body can be positioned such that the body central opening aligns with a corresponding opening in netting 90, as shown in FIG. 6b. Funnel 20 is then positioned over the opening, attaching to body 15, as shown in FIG. 6c. The lid can then attach to the top surface of the body, with netting therebetween, as shown in FIGS. 6d and 6e. The device is then functional to trap mosquitoes.

It should be appreciated that collection bag 115 can be configured in any suitable size to hold a desired volume. For example, the collection bag can have a volume of approximately 5, 10, 15, 20, 25, or 30 liters or more. A collection bag of any size can be used.

In use, a person or animal can be housed within the interior of a portion of netting 90, such as during sleeping, resting, working, and the like so that the person or animal is separated from the external environment. The netting includes a screen size too small for an adult mosquito to pass through. In some embodiments, the netting can be draped over a bed or other sleeping surface. Mosquitoes are attracted to the person or animal via exhalation of carbon dioxide, body heat, and/or smell. In an effort to get closer to the human or animal, a mosquito will enter the MTD by passing from the exterior environment into the passageway created by the central openings of the lid and attached body. The mosquito will then enter the interior of the funnel, passing from the funnel upper end 70 to the lower end 75 where it exits the MTD and is trapped within collection bag 115. The mosquitoes can then be easily killed or destroyed. In this way, the mosquitoes are prevented from reaching the person or animal. As a result, the incidence of mosquito-transmitted malaria can be reduced.

In addition to being used with mosquito netting, the disclosed device can also be used as a standalone trapping tool. For example, light can be added as bait to attract mosquitoes, and the device can be hung outdoors or indoors. The bait can be light or any other mosquito or insect attractants such as odors, sugar, lures, and the like. A trapping bag can be attached to the device to capture the mosquitoes.

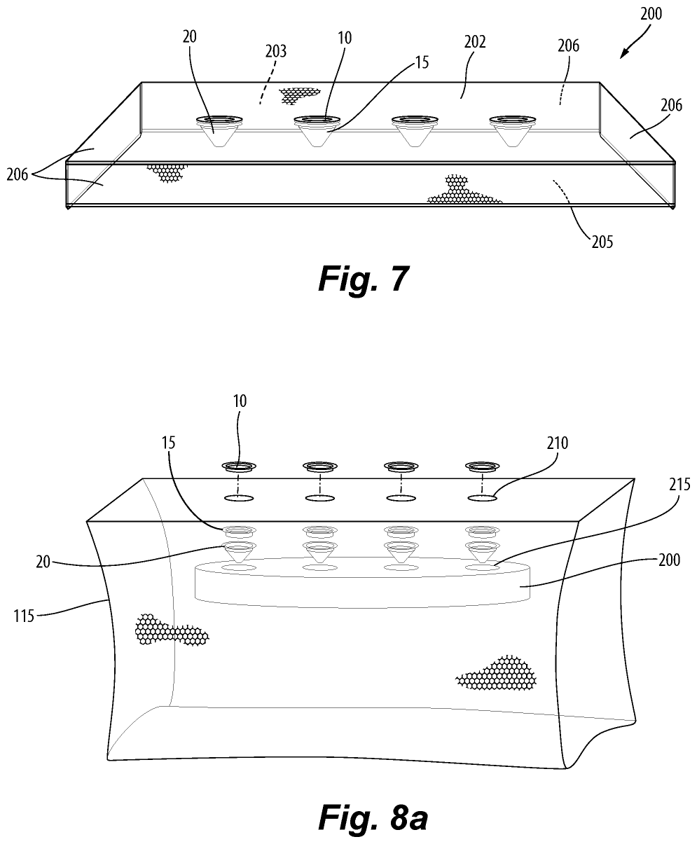

In a second embodiment, the invention includes a device (e.g., a box) that can be attached to the net. The device acts as a two-compartment mosquito net (e.g., the collection bag is replaced by a trap box). The mosquito box can be affixed to the top surface of the net using any suitable mechanism, such as an attaching strap, VELCRO®, buttons, snaps, zippers, and the like. As illustrated in FIG. 7, box 200 is constructed from netting or any other mosquito-impermeable material that ensures that any mosquito that enters the box interior cannot escape. The box includes one or more funnels 20 that each cooperate with an associated lid 10 and body 15. The funnels are positioned on the upper surface 202 of the box and extending into box interior 203, providing a passageway for mosquitoes to enter the interior of the box. Box 200 can include upper and opposed lower surfaces 202, 205 and a plurality of side faces 206. However, it should be appreciated that the shape of the box is not limited, and the box can be configured in any desired shape such as square, rectangular, triangular, hexagonal, and the like. Any shape can be used.

The funnels, lids, and bodies can be constructed from any suitable material, such as (but not limited to) fiberglass, plastic, and/or nylon. The funnels can be attached using any known mechanism, such as (but not limited to) sewing, molding, or fastening. The funnels can have any suitable dimensions. The funnels can be placed lengthwise, widthwise, diagonally, and/or randomly (on any surface of the box).

Advantageously, in these embodiments there is no need to modify an existing mosquito net. Rather, the box can be a stand-alone tool, functioning as a large trapping chamber.

FIGS. 8a and 8b illustrate one embodiment of using the disclosed box. As shown, the top surface of netting 115 can include one or more openings 210 that are sized and shaped to house the lid, body, and funnel as disclosed herein. The lid remains on the top surface of the netting, while the body and funnel extend into the interior of the netting.

Box 200 (including openings 215 on a top face) then cooperates with the one or more bodies and funnels, creating an interior compartment within the netting. As shown, the body and funnels can extend through box openings 215 to be housed within the interior of the box. The box can be constructed from any material, such as (but not limited to) metal, plastic, cardboard, glass, plexiglass, ceramics, netting 115, or combinations thereof. A mosquito can then enter the interior of the box and become trapped for disposal by traveling through lid 10 via net opening 210 and following the passageway from the body and funnel into the box interior.

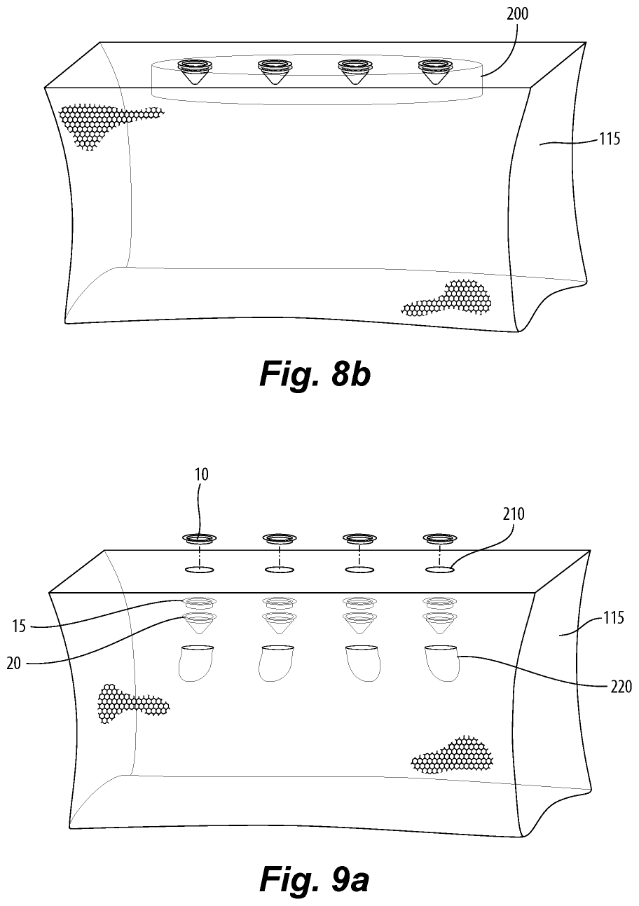

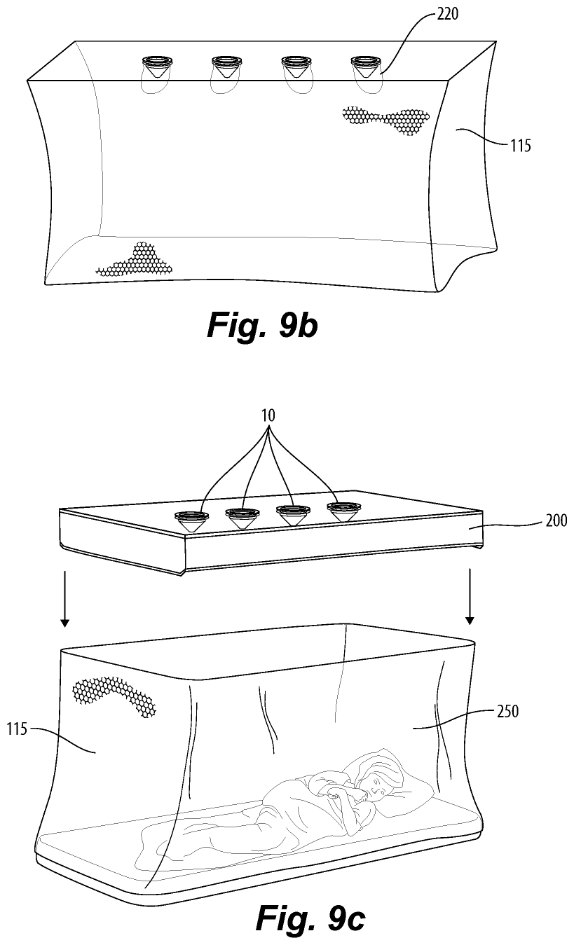

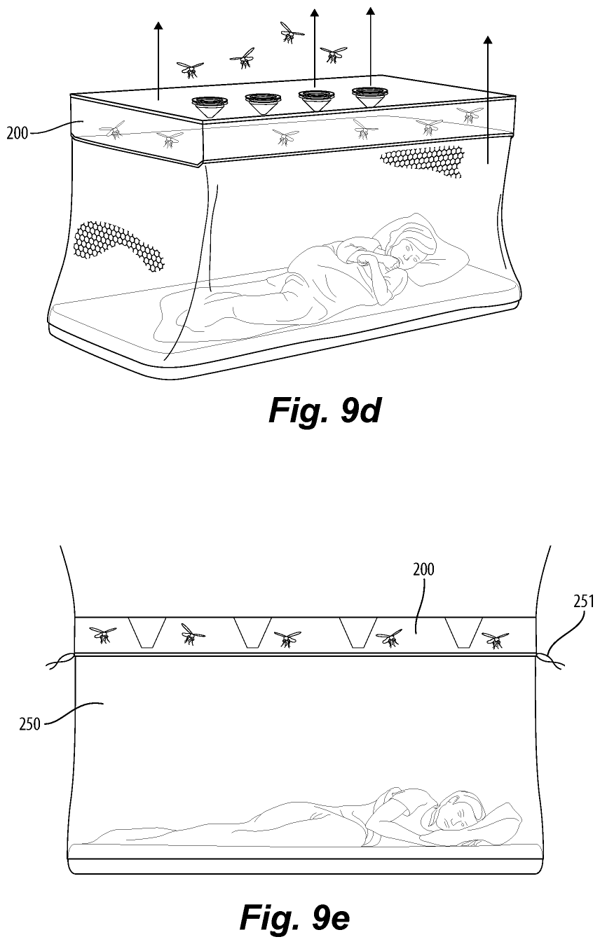

In some embodiments, a collection bag 220 can be attached to the funnel system (surrounding the exposed surface within the interior of the netting and/or within the box), as shown in FIGS. 9a and 9b. FIGS. 9c and 9d illustrate box 200 being inserted adjacent to a top surface of a sleeping enclosure 250 bound by mosquito netting on some or all sides. The box can be secured using any element or method, such as resting atop the top face of the sleeping enclosure, VELCRO®, snaps, buckles, straps 251, and the like, as shown in FIG. 9e.

Thus, the box can be configured as a large trapping container that includes an interior acting as a mosquito enclosure. The funnels are present for mosquito entry. A sleeping compartment can be positioned below the box, where mosquitoes become trapped within the box. The sleeping compartment can be insecticide treated. It has been shown that approximately 75% of all mosquito activity occurs at a bed roof (Parker, J., Sci. Rep. 5, 13392 (2015) and Gleave et al. Malaria Journal (2023) 22:132) and Table 1 below:

| Treatment | Strain | Roof | Front | Sides |
|---|---|---|---|---|
| Untreated | Kisumu | 93.91 | 5.81 | 0.28 |
| | N'gousso | 96.49 | 2.83 | 0.69 |
| | VK7 | 91.64 | 7.51 | 0.86 |
| | Banfora | 95.73 | 3.47 | 0.80 |
| Olyset Net | Kisumu | 92.58 | 7.09 | 0.33 |
| | N'gousso | 86.39 | 10.27 | 3.34 |
| | VK7 | 86.59 | 11.99 | 1.42 |
| | Banfora | 85.22 | 13.15 | 1.63 |
| Permanent | Kisumu | 92.33 | 6.64 | 1.03 |
| 3.0 | N'gousso | 92.23 | 6.53 | 1.24 |
| | VK7 | 87.87 | 9.77 | 2.36 |

VK7 is an insecticide-resistant strain.

Banfora is an insecticide-resistant strain.

Kisumu is an insecticide-susceptible strain.

N'gousso is an insecticide-susceptible strain.

Although the disclosed MTD has been discussed herein primarily with reference to preventing the spread of mosquito-borne malaria, it should be appreciated that the device can be used to prevent or decrease the incidence of a wide variety of insect-borne diseases. In addition to malaria, the disclosed MTD can be used to prevent dengue fever, yellow fever, zika virus, Chagas disease, as wells various forms of encephalitis, including the West Nile virus.

The disclosed device provides many advantages over prior art mosquito trapping devices. For example, MTD 5 can capture mosquitoes regardless of their insecticide resistance status.

The MTD is easy to use and can be easily installed or retrofitted onto existing bed nets such that even children or the elderly can install and use the device.

Use of the disclosed MTD can increase mass mosquito trapping, leading to a decline in the vector population and consequently decreasing the malaria transmission and malaria burden.

MTD 5 exhibits a lack of complexity, thereby leading to use in inexpensive vector control.

The disclosed MTD further does not require frequent servicing to maintain effectiveness.

The MTD is cost-effective to construct, allowing for reasonable price savings to be passed onto the consumer.

The vector population decrease attributed to the disclosed MTD is even more likely in the context of insecticide resistance where mosquito mortality by regular insecticide treated nets is lower than expected. The disclosed MTD may therefore be relevant as a resistance management tool, especially if it is used on non-insecticide treated bed nets that do not select for insecticide resistance. Stated another way, the disclosed device can be used to trap mosquitoes without contributing to insecticide resistance of the mosquitoes.

The disclosed device can be used to trap mosquitos. Particularly, a portion of mosquito netting defined by an opening can be positioned between the lid and body of a mosquito trapping device. The mosquito trapping device is exposed to an ambient environment that includes mosquitoes. Mosquitos enter the mosquito trapping device via the lid central opening, pass through the net opening, pass through the body central opening, enter the funnel interior passageway, and exit at the funnel lower end to become trapped within the collection bag.

In the box device embodiments, the method of trapping mosquito can include positioning a portion of mosquito netting defined by an opening between the lid and body of a mosquito trapping device. The method includes exposing the mosquito trapping device to an ambient environment that includes mosquitoes, whereby mosquitos enter the mosquito trapping device via the lid central opening, pass through the net opening, pass through the body central opening, enter the funnel interior passageway, and exit at the funnel lower end to become trapped within the interior of the box.

The disclosed device can be used to prevent the spread of a mosquito-borne disease. Particularly, a portion of mosquito netting defined by an opening can be positioned between the lid and body of a mosquito trapping device. The lid ridge releasably attaches to the body and the body flange releasably attaches to the funnel. The lid and body can be releasably secured together with the mosquito netting therebetween, wherein the netting opening is aligned with the central openings of the lid and body. A collection bag can be attached about an exterior surface of the funnel. Mosquitos enter the mosquito trapping device via the lid central opening, pass through the net opening, pass through the body central opening, enter the funnel interior passageway, and exit at the funnel lower end to become trapped within the collection bag. The mosquitos are prevented from infecting a subject with a mosquito-borne disease due to being trapped in the collection bag.

In embodiments of the device that include the box, the method of preventing the spread of a mosquito-borne disease comprises positioning a portion of mosquito netting defined by one or more openings between the one or more lids and one or more bodies of the mosquito trapping device, wherein the one or more lid ridges releasably attach to the one or more bodies and the one or more body flanges releasably attach to the one or more funnels. The method includes releasably securing the one or more lids and one or more bodies together with the mosquito netting therebetween, wherein each netting opening is aligned with a central opening of a lid and body. The method comprises attaching a collection bag about an exterior surface of each funnel, whereby mosquitos enter the mosquito trapping device via the lid central opening, pass through the net opening, pass through the body central opening, enter the funnel interior passageway, and exit at the funnel lower end to become trapped within the interior of the box. The mosquitos are prevented from infecting a subject with the mosquito-borne disease due to being trapped in the interior of the box.

In some embodiments, the mosquito-borne disease is selected from one or more of malaria, heartworm, West Nile virus, Eastern equine encephalitis (EEE), dengue fever, yellow fever, zika virus, Chagas disease, and encephalitis.

The disclosed device can be used to manage insecticide resistance. Specifically, a portion of mosquito netting defined by an opening can be positioned between the lid and body of a mosquito trapping device, wherein the lid ridge releasably attaches to the body and the body flange releasably attaches to the funnel. The lid and body can be releasably attached together with the mosquito netting therebetween, wherein the netting opening is aligned with the central openings of the lid and body and attaching a collection bag about an exterior surface of the funnel. Mosquitos enter the mosquito trapping device via the lid central opening, pass through the net opening, pass through the body central opening, enter the funnel interior passageway, and exit at the funnel lower end to become trapped within the collection bag. In this way, mosquito insecticide resistance is managed (e.g., the mosquitoes are trapped and disposed of without the use of insecticide-which thereby does not contribute to insecticide resistance of mosquitoes).

In embodiments of the device that include the box feature, insecticide resistance can be managed by positioning a portion of mosquito netting defined by an opening between each lid and body of a mosquito trapping device, wherein each lid ridge releasably attaches to a body and each body flange releasably attaches to a funnel. Each lid and body can be releasably attached together with the mosquito netting therebetween, wherein the netting opening is aligned with the central openings of the lid and body and attaching a collection bag about an exterior surface of each funnel. Mosquitos enter the mosquito trapping device via the lid central opening(s), pass through the net opening(s), pass through the body central opening(s), enter each funnel interior passageway, and exit at the funnel lower end to become trapped within the box interior. In this way, mosquito insecticide resistance is managed. Stated another way, mosquitoes that carry a gene for insecticide resistance can be trapped and exposed of (e.g., killed) to reduce the number of mosquitoes that carry the gene.

In some embodiments, the device can be used to control mosquitoes (e.g., control the spread of mosquitoes). Particularly, the method comprises positioning a portion of mosquito netting in a high mosquito density area, the mosquito netting defined by an opening between the lid and body of a mosquito trapping device, wherein the lid ridge releasably attaches to the body and the body flange releasably attaches to the funnel. The method includes releasably securing the lid and body together with the mosquito netting therebetween, wherein the netting opening is aligned with the central openings of the lid and body. The method comprises attaching a collection bag about an exterior surface of the funnel, whereby mosquitos enter the mosquito trapping device via the lid central opening, pass through the net opening, pass through the body central opening, enter the funnel interior passageway, and exit at the funnel lower end to become trapped within the collection bag. As a result, the mosquitoes are controlled (e.g., the number of mosquitoes are reduced) in the high mosquito density region. A “high mosquito density region” refers to a region with a population of mosquitoes that are higher than the average number of mosquitoes present in an area. The increased number of mosquitoes can be due to many factors, such as weather, rainfall, presence of standing water, etc. One example of a high density region is a rice farming region.

In embodiments of the device that include the box feature, mosquitoes can be controlled by positioning a portion of mosquito netting in a high mosquito density area, the mosquito netting defined by one or more openings between each lid and body of a mosquito trapping device, wherein each lid ridge releasably attaches to the body and the body flange releasably attaches to a funnel. The method includes releasably securing each lid and body together with the mosquito netting therebetween, wherein the netting opening is aligned with the central openings of corresponding lids and bodies. The method comprises attaching a collection bag about an exterior surface of the funnel within the interior of the box, whereby mosquitos enter the mosquito trapping device via the lid central opening, pass through the net opening, pass through the body central opening, enter the funnel interior passageway, and exit at the funnel lower end to become trapped within the interior of the box. As a result, the mosquitoes are controlled in the high mosquito density region (e.g., the number of mosquitoes are reduced).

The foregoing description has been set forth merely to illustrate the invention and are not intended to be limiting. Each of the disclosed aspects and embodiments of the invention may be considered individually or in combination with other aspects, embodiments, and variations of the invention. In addition, unless otherwise specified, the steps of the methods of the invention are not confined to any particular order of performance. Modifications of the disclosed embodiments incorporating the spirit and substance of the invention may occur to persons skilled in the art, and such modifications are within the scope of the invention.

### EXAMPLES

### Example 1

### Construction of MTD

It has been determined that most interactions with bed nets occur on the net roof and likewise many other insects and mosquitoes are attracted by light. The MTD was tested on non-insecticide treated bed nets in the presence and absence of light using a fiberglass material MTD.

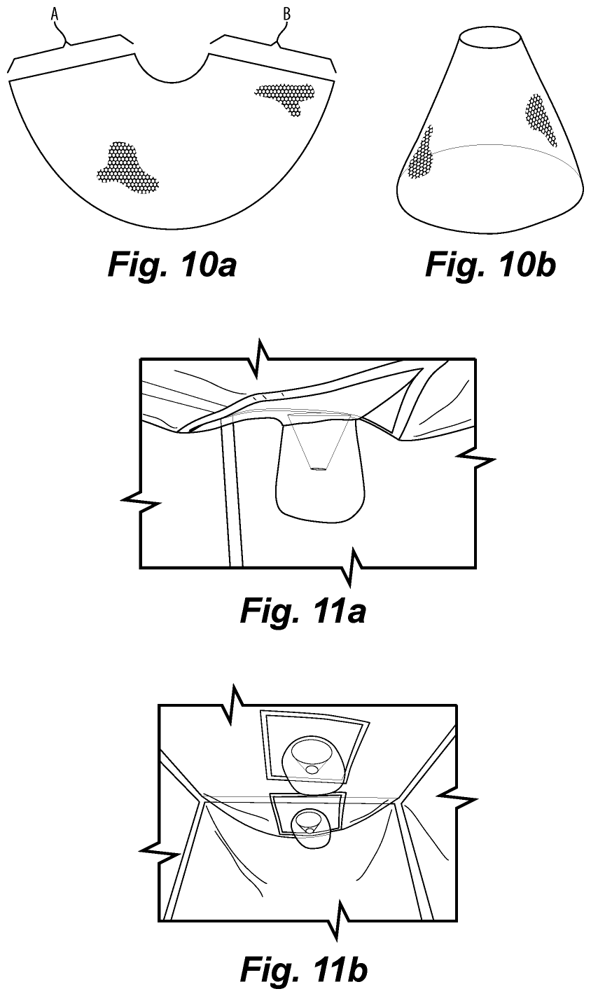

Knowing the desired dimensions of the funnel on the MTD (15 cm in the large diameter, 12 cm deep, and 3 cm in the small diameter, with a 51.3 degree of inclination angle), a flat view surface segment was used as a template. As shown in FIGS. 10a and 10b, ends A and B of the funnel segment were sewn together to form the desired funnel shape.

Several fiberglass fabrics of different thickness and mesh were considered, and a 20-by-20 mesh screen size was selected. The mesh provided tear and wrinkle resistance and facilitated the passage of light. The funnels were successfully sewed on the roof of the mosquito bed nets, as shown in FIGS. 11a and 11b.

### Example 2

### Positioning of the MTD on a Bed Net

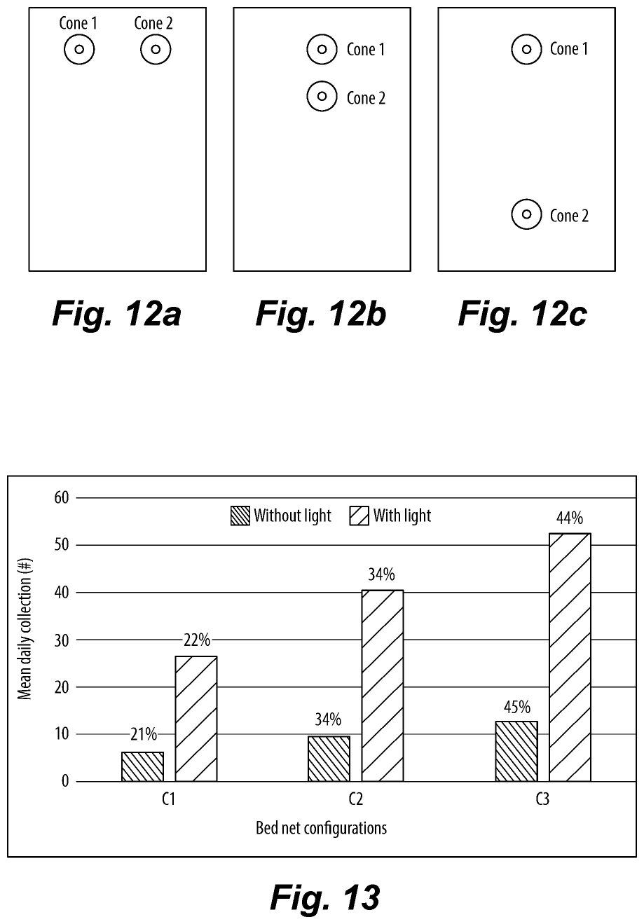

To confirm effectiveness on a bed net, the position of the MTD was evaluated for optimal performance. Several MTDs were attached at varying locations on insecticide-free bed nets. FIG. 12a (configuration A) illustrates one embodiment with 2 MTD funnels positioned in a side-by-side orientation width-wise on one half of the bed net. FIG. 12b illustrates a second configuration (configuration B) with two MTD funnels positioned side-by-side lengthwise on one half of a bed net. FIG. 12c illustrates a third configuration (configuration C) with two MTD funnels positioned lengthwise on each half of a bed net.

The study was carried out in households in Sakassou village (7° 45′ 0″ N, 5° 1′ 0″ W), Côthe d'Ivoire. The households' heads consented to participate in the study. The study lasted 6 weeks during which bed nets with MTDs were used every night. The same bed nets were first used without light for 30 days and then with light for 14 days. Bed nets were rotated between household to avoid bias of preference attraction from a household or a sleeper.

### Results

Without light, the average number of mosquitoes collected daily was 6 for configuration A, 10 for configuration B, and 13 for configuration C, as shown in Table 1 below. It was determined that configuration C was the most favorable, comprising 45% of the capture rate compared to 35% for configuration B and 21% for configuration A.

TABLE 1
Mean Mosquito Daily Trapping Rate per Bed Net Without Light

| | Configuration A | | Configuration B | | Configuration C | |
|---|---|---|---|---|---|---|
| | Funnel 1 | Funnel 2 | Funnel 1 | Funnel 2 | Funnel 1 | Funnel 2 |
| Total Mean | 102 | 79 | 177 | 104 | 200 | 170 |
| Average | 3.52 | 2.72 | 6.10 | 3.59 | 6.90 | 5.86 |
| Std. Dev. | 4.32 | 2.55 | 5.86 | 2.61 | 6.50 | 4.92 |

| | | | |
|---|---|---|---|
| Total Mean Daily | 6.24 | 9.69 | 12.76 |
| Collected | | | |
| Mean Percentage | 21 | 34 | 45 |
| Daily Collection | | | |

With light, the average number of mosquitos collected daily was 27 for configuration A, 41 for configuration B, and 52 for configuration C, as shown in Table 2 below. It was determined that configuration C was the most favorable, comprising 44% of the capture rate compared to 34% for configuration B and 22% for configuration A.

TABLE 2
Mean Mosquito Daily Trapping Rate per Bed Net With Light

| | Configuration A | | Configuration B | | Configuration C | |
|---|---|---|---|---|---|---|
| | Funnel 1 | Funnel 2 | Funnel 1 | Funnel 2 | Funnel 1 | Funnel 2 |
| Total Mean | 238 | 133 | 355 | 212 | 466 | 268 |
| Average | 17.00 | 9.50 | 25.36 | 15.14 | 33.29 | 19.14 |
| Std. Dev. | 4.02 | 4.29 | 5.47 | 4.85 | 7.63 | 6.55 |

| | | | |
|---|---|---|---|
| Total Mean Daily | 26.5 | 40.5 | 52.43 |
| Collected | | | |
| Mean Percentage | 22 | 34 | 44 |
| Daily Collection | | | |

It was observed that the findings with light were consistent with those results observed without light. The data confirms that Configuration C best attracted mosquitoes, and the addition of light increased the trapping rate by more than 4-fold, as shown in the graph of FIG. 13.

What is claimed is:

1. A mosquito trapping device comprising:
a lid defined by:
a planar surface with a top face and an opposed bottom face;
a ridge extending from the bottom face of the planar surface, away from the lid; and
a central opening that passes through the planar surface and ridge;
a body defined by:
a planar surface comprising a top face and an opposed bottom face;
a flange extending from the bottom face of the planar surface, away from the body;
a funnel defined by:
a top end and an opposed bottom end; and
an interior tapered passageway positioned between the top and bottom ends;
wherein the lid ridge releasably attaches to the body and the body flange releasably attaches to the funnel.

2. The mosquito trapping device of claim 1, further comprising a mosquito net defined by an opening, wherein the opening is positioned between the central opening of the lid and the central opening of the body.

3. The mosquito trapping device of claim 1, wherein the funnel is angled between the top end and the bottom end with a degree of inclination of about 1-180 degrees.

4. The mosquito trapping device of claim 1, wherein the funnel comprises a plurality of apertures along an external surface between the top end and the bottom end, and wherein the plurality of apertures allow for the influx of light, disperse carbon dioxide, or both.

5. A mosquito trapping device comprising:
one or more lids, each lid defined by:
a planar surface with a top face and an opposed bottom face;
a ridge extending from the bottom face of the planar surface, away from the lid; and
a central opening that passes through the planar surface and ridge;
one or more bodies, each defined by:
a planar surface comprising a top face and an opposed bottom face;
a flange extending from the bottom face of the planar surface, away from the body;
one or more funnels, each funnel defined by:
a top end and an opposed bottom end; and
an interior tapered passageway positioned between the top and bottom ends;
a mosquito net defined by one or more openings, wherein each opening is positioned between the central opening of a lid and the central opening of a body;
a box attached to the net, wherein the box includes a top surface comprising one or more openings aligned with the one or more openings in the mosquito net, such that the box is positioned below an upper surface of the mosquito net;
wherein each lid ridge releasably attaches on a top side of the mosquito net through a mosquito net opening to a body positioned within an interior of the mosquito net, and each body flange releasably attaches to a funnel such that each funnel extends through a box opening and each funnel is positioned within an interior of the box.

6. The mosquito trapping device of claim 5, wherein each funnel is angled between the top end and the bottom end with a degree of inclination of about 1-180 degrees.

7. A method of trapping mosquitos, the method comprising:
positioning a portion of mosquito netting defined by an opening between the lid and body of a mosquito trapping device of claim 1;
exposing the mosquito trapping device to an ambient environment that includes mosquitoes;
whereby mosquitos enter the mosquito trapping device via the lid central opening, pass through the net opening, pass through the body central opening, enter the funnel interior passageway, and exit at the funnel lower end to become trapped within the collection bag.

8. A method of trapping mosquitos, the method comprising:
positioning a portion of mosquito netting defined by an opening between the lid and body of a mosquito trapping device of claim 5;
exposing the mosquito trapping device to an ambient environment that includes mosquitoes;
whereby mosquitos enter the mosquito trapping device via the one or more lid central openings, pass through the one or more net openings, pass through the one or more body central openings, enter the one or more funnel interior passageways, and exit at a funnel lower end to become trapped within the interior of the box.

9. A method of preventing the spread of a mosquito-borne disease, the method comprising:
positioning a portion of mosquito netting defined by an opening between the lid and body of the mosquito trapping device of claim 1, wherein the lid ridge releasably attaches to the body and the body flange releasably attaches to the funnel;
releasably securing the lid and body together with the mosquito netting therebetween, wherein the netting opening is aligned with the central openings of the lid and body;
attaching a collection bag about an exterior surface of the funnel;
whereby mosquitos enter the mosquito trapping device via the lid central opening, pass through the net opening, pass through the body central opening, enter the funnel interior passageway, and exit at the funnel lower end to become trapped within the collection bag; and
whereby the mosquitos are prevented from infecting a subject with the mosquito-borne disease due to being trapped in the collection bag.

10. The method of claim 9, wherein the mosquito-borne disease is selected from one or more of malaria, heartworm, West Nile virus, Eastern equine encephalitis (EEE), dengue fever, yellow fever, zika virus, Chagas disease, and encephalitis.

11. The method of claim 9, wherein the subject is a human or animal.

12. The method of claim 9, wherein the funnel is angled between the top end and the bottom end with a degree of inclination of about 1-180 degrees.

13. A method of preventing the spread of a mosquito-borne disease, the method comprising:
positioning a portion of mosquito netting defined by one or more openings between the one or more lids and one or more bodies of the mosquito trapping device of claim 5, wherein the one or more lid ridges releasably attach to the one or more bodies and the one or more body flanges releasably attach to the one or more funnels;
releasably securing the one or more lids and one or more bodies together with the mosquito netting therebetween, wherein each netting opening is aligned with a central opening of a lid and body;
attaching a collection bag about an exterior surface of each funnel;
whereby mosquitos enter the mosquito trapping device via the lid central opening, pass through the net opening, pass through the body central opening, enter the funnel interior passageway, and exit at the funnel lower end to become trapped within the collection bag or within the interior of the box; and
whereby the mosquitos are prevented from infecting a subject with the mosquito-borne disease due to being trapped in the one or more collection bags.

14. The method of claim 13, wherein the mosquito-borne disease is selected from one or more of malaria, heartworm, West Nile virus, Eastern equine encephalitis (EEE), dengue fever, yellow fever, zika virus, Chagas disease, and encephalitis.

15. The method of claim 13, wherein the subject is a human or animal.

16. The method of claim 13, wherein each funnel is angled between the top end and the bottom end with a degree of inclination of about 1-180 degrees.

17. A method of controlling mosquitoes, the method comprising:
positioning a portion of mosquito netting in a high mosquito density area, the mosquito netting defined by an opening between the lid and body of the mosquito trapping device of claim 1, wherein the lid ridge releasably attaches to the body and the body flange releasably attaches to the funnel;
releasably securing the lid and body together with the mosquito netting therebetween, wherein the netting opening is aligned with the central openings of the lid and body;
attaching a collection bag about an exterior surface of the funnel;
whereby mosquitos enter the mosquito trapping device via the lid central opening, pass through the net opening, pass through the body central opening, enter the funnel interior passageway, and exit at the funnel lower end to become trapped within the collection bag; and
whereby the mosquitoes are controlled in the high mosquito density region.

18. A method of controlling mosquitoes, the method comprising:
positioning a portion of mosquito netting in a high mosquito density area, the mosquito netting defined by one or more openings between the one or more lids and one or more bodies of the mosquito trapping device of claim 5, wherein each lid ridge releasably attaches to a body and each body flange releasably attaches to a funnel;
releasably securing each lid and body together with the mosquito netting therebetween, wherein each netting opening is aligned with the central openings of the lid and body;
whereby mosquitos enter the mosquito trapping device via the one or more lid central openings, pass through the one or more net openings, pass through the one or more body central openings, enter the one or more funnel interior passageways, and exit at the one or more funnel lower ends to become trapped within the collection bag or within the interior of the box; and
whereby the mosquitoes are controlled in the high mosquito density region.

19. A method of managing insecticide resistance in mosquitoes, the method comprising:
positioning a portion of mosquito netting in a high mosquito density area, the mosquito netting defined by an opening between the lid and body of the mosquito trapping device of claim 1, wherein the lid ridge releasably attaches to the body and the body flange releasably attaches to the funnel;
releasably securing the lid and body together with the mosquito netting therebetween, wherein the netting opening is aligned with the central openings of the lid and body;
attaching a collection bag about an exterior surface of the funnel;
whereby mosquitos enter the mosquito trapping device via the lid central opening, pass through the net opening, pass through the body central opening, enter the funnel interior passageway, and exit at the funnel lower end to become trapped within the collection bag; and
whereby the spread of insecticide resistant mosquitoes is decreased by the trapping of the mosquitoes within the collection bag.

20. A method of managing insecticide resistance, the method comprising:
positioning a portion of mosquito netting in a high mosquito density area, the mosquito netting defined by one or more openings between the one or more lids and one or more bodies of the mosquito trapping device of claim 5, wherein each lid ridge releasably attaches to a body and each body flange releasably attaches to a funnel;
releasably securing each lid and body together with the mosquito netting therebetween, wherein each netting opening is aligned with the central openings of the lid and body;
whereby mosquitos enter the mosquito trapping device via the one or more lid central openings, pass through the one or more net openings, pass through the one or more body central openings, enter the one or more funnel interior passageways, and exit at the one or more funnel lower ends to become trapped within the interior of the box; and
whereby the spread of insecticide resistant mosquitoes is decreased by the trapping of the mosquitoes within the interior of the box.
